(19) United States
(12) Patent Application Publication
(10) Pub. No.: US 2017/0289507 A1
(43) Pub. Date: Oct. 5, 2017

(54) DISPLAY APPARATUS, IMAGE PROCESSING APPARATUS, AND DISPLAY METHOD

(71) Applicant: SEIKO EPSON CORPORATION, Tokyo (JP)

(72) Inventor: Tatsuya IGUCHI, Matsumoto-Shi (JP)

(73) Assignee: SEIKO EPSON CORPORATION, Tokyo (JP)

(21) Appl. No.: 15/468,989

(22) Filed: Mar. 24, 2017

(30) Foreign Application Priority Data
Mar. 30, 2016 (JP) 2016-067499

(51) Int. Cl. H04N 9/31

(52) U.S. Cl. CPC H04N 9/3155; H04N 9/3138; H04N 9/3164; H04N 9/3179

(57) ABSTRACT

A projector includes a light adjustment information determination section that determines light adjustment information in accordance with which light adjustment blocks of a light adjustment liquid crystal panel are controlled, in which the light adjustment liquid crystal panel has first pixel that modulate light based on image data inputted to an image I/F section and second pixel that modulate light based on parting pixel data, and the light adjustment information determination section determines, based on the parting pixel data, light adjustment information on light adjustment blocks that adjust light incident on the second pixel.

The entire disclosure of Japanese Patent Application No. 2016-67499, filed Mar. 30, 2016 is expressly incorporated by reference herein.

### BACKGROUND

### 1. Technical Field

The present invention relates to a display apparatus, an image processing apparatus, and a display method.

### 2. Related Art

There is a known display apparatus of related art that causes a modulator to modulate light emitted from a light source and displays the resultant image. To increase the contrast and quality of the image displayed by the display apparatus, there is a proposed apparatus including an illuminator that adjusts the amount of light from the light source in accordance with image data (see JP-T-2004-523001, for example).

JP-T-2004-523001 discloses a high-dynamic-range display apparatus including a second light modulator including a large number of addressable elements and capable of controlling each of the elements in such a way that the element affects the luminance of the corresponding area of a screen.

As the modulator provided in the display apparatus, there is a modulator having pixels in addition to pixels used to display an image based on image data inputted to an image input section. In this configuration, no method of related art for performing light adjustment corresponding to the pixels has been proposed.

### SUMMARY

An advantage of some aspects of the invention is to perform light adjustment corresponding to each pixel provided in a modulator that modulates light.

A display apparatus according to an aspect of the invention includes an image input section that inputs image data, a display section that includes a modulator having a plurality of pixels and an illuminator that includes a plurality of light adjustment elements and outputs light adjusted by the plurality of light adjustment elements to the modulator, and a light adjustment information determination section that determines light adjustment information in accordance with which the light adjustment elements of the illuminator are controlled. The modulator has first pixel that modulate light based on the image data inputted to the image input section and second pixel that modulate light based on predetermined image data, and the light adjustment information determination section determines, based on the predetermined image data, light adjustment information on the light adjustment element that adjust light incident on the second pixel.

According to the configuration of the aspect of the invention, light adjustment information on the light adjustment element that adjust light incident on the first pixel is determined on the basis of the image data inputted to the image input section, and light adjustment information on the light adjustment element that adjust light incident on the second pixel is determined on the basis of the predetermined image data. The light incident on the first and second pixel can therefore be adjusted.

In the display apparatus described above, the light adjustment information determination section may determine, based on the image data inputted to the image input section and the predetermined image data, light adjustment information on the light adjustment element that adjust light incident on the first and second pixel.

According to this configuration of the aspect of the invention, light adjustment information on the light adjustment element that adjust light incident on the first and second pixel is determined on the basis of the image data inputted to the image input section and the predetermined image data. The values of the image data inputted to the image input section and the values of the predetermined image data can be reflected in the light adjustment information on the light adjustment element, whereby the light adjustment information on the light adjustment element can be set to have optimum value.

In the display apparatus described above, the light adjustment information determination section may determine, based on the image data inputted to the image input section, light adjustment information on the light adjustment element that adjust light incident on the first pixel.

According to this configuration of the aspect of the invention, light adjustment information on the light adjustment element corresponding to the first pixel is determined on the basis of the image data inputted to the image input section. The values of the image data inputted to the image input section can therefore be reflected in the light adjustment information on the light adjustment element, whereby the light adjustment information on the light adjustment element can be set to have optimum value.

In the display apparatus described above, the illuminator may adjust light incident on a plurality of the pixels of the modulator on a light adjustment element basis, and with regard to the light adjustment element that adjust light incident on the first and second pixel, the light adjustment information determination section may determine light adjustment information on the light adjustment element based on the image data inputted to the image input section and the predetermined image data.

According to this configuration of the aspect of the invention, light adjustment information on the light adjustment element that adjust light incident on the first and second pixel is determined on the basis of the image data inputted to the image input section and the predetermined image data. The values of the image data inputted to the image input section and the values of the predetermined image data can be reflected in the light adjustment information on the light adjustment element, whereby the light adjustment information on the light adjustment element can be set to have optimum value.

In the display apparatus described above, with regard to the light adjustment element that adjust light incident on the second pixel, the light adjustment information determination section may determine light adjustment information on the light adjustment element based on the predetermined image data.

According to this configuration of the aspect of the invention, light adjustment information on the light adjustment element that adjust light incident on the second pixel is determined on the basis of the predetermined image data. The light adjustment information on the light adjustment element corresponding to the second pixel can therefore be efficiently determined, whereby the processing efficiency of the display apparatus including the illuminator, which adjusts light, can be improved.

In the display apparatus described above, the light adjustment information determination section may statistically process the predetermined image data to calculate an amount of characteristic used to determine light adjustment information, and when image data is inputted to the image input section, the light adjustment information determination section may determine, based on the amount of characteristic, light adjustment information on the light adjustment element that adjust light incident on the second pixel.

According to this configuration of the aspect of the invention, light adjustment information on the light adjustment element that adjust light incident on the second pixel is determined on the basis of the amount of characteristic calculated in advance. The light adjustment information on the light adjustment element corresponding to the second pixel can therefore be efficiently determined, whereby the processing efficiency of the display apparatus including the illuminator, which adjusts light, can be improved.

In the display apparatus described above, the light adjustment information determination section may statistically process at least one of the image data inputted to the image input section and the predetermined image data to calculate at least one of a maximum, a minimum, and an average of pixel values of the image data as an amount of characteristic and determine light adjustment information based on the calculated amount of characteristic.

According to this configuration of the aspect of the invention, at least one of the maximum, minimum, and average of the pixel values of the image data is calculated as the amount of characteristic representing the characteristic of the image data, and light adjustment information is determined on the basis of the calculated amount of characteristic. The light adjustment information can therefore be determined on the basis of at least one of the maximum, minimum, and average of the pixel values of the image data.

In the display apparatus described above, the light adjustment information determination section may determine, based on an amount of characteristic of the predetermined image data that is externally inputted, light adjustment information on the light adjustment element that adjust light incident on the second pixel.

According to this configuration of the aspect of the invention, light adjustment information on the light adjustment element is determined on the basis of the amount of characteristic of the externally inputted predetermined image data. The display apparatus needs to have no configuration that calculates the amount of characteristic, whereby the configuration of the display apparatus can be made compact.

In the display apparatus described above, the modulator may have a plurality of display pixels including the first pixel that display an image based on the image data inputted to the image input section and the second pixel that display an image based on the predetermined image data, and the light adjustment information determination section may determine, based on the predetermined image data, light adjustment information in accordance with which an amount of light of the image displayed by the second pixel is controlled.

According to this configuration of the aspect of the invention, the first pixel display an image based on the image data, and the second pixel display an image based on the predetermined image data. The amount of light of the image displayed by the second pixel is determined by the light adjustment information set by the light adjustment information determination section.

The display apparatus described above may further include a storage section that stores pixel values of the predetermined image data.

According to this configuration of the aspect of the invention, light adjustment information on the light adjustment element that adjust light incident on the second pixel is determined by using the pixel values of the predetermined image data stored in the storage section. The light adjustment information on the light adjustment element that adjust light incident on the second pixel can therefore be readily determined.

The display apparatus described above may be a projector including a light source and a projection system that projects an image displayed by the display section.

According to this configuration of the aspect of the invention, in a projector including a modulator that modulates light and a light adjuster that adjusts the light incident on the modulator, light adjustment corresponding to the pixels provided in the modulator, which modulates light, can be performed.

An image processing apparatus according to another aspect of the invention includes a light adjustment information determination section provided in a display apparatus including a modulator having a plurality of pixels including first pixel that modulate light based on inputted image data and second pixel that modulate light based on predetermined image data and an illuminator that includes a plurality of light adjustment elements and outputs light adjusted by the plurality of light adjustment elements to the modulator. The light adjustment information determination section determines light adjustment information in accordance with which the light adjustment elements are controlled, and the light adjustment information determination section determines, based on the predetermined image data, light adjustment information on light adjustment element that adjust light incident on the second pixel.

According to the configuration of the aspect of the invention, light adjustment information on the light adjustment element that adjust light incident on the first pixel is determined on the basis of the inputted image data, and light adjustment information on the light adjustment element that adjust light incident on the second pixel is determined on the basis of the predetermined image data. The light incident on the first and second pixel can therefore be adjusted.

A display method according to another aspect of the invention is used with a display apparatus including a modulator having a plurality of pixels including first pixel that modulate light based on inputted image data and second pixel that modulate light based on predetermined image data and an illuminator that includes a plurality of light adjustment elements and outputs light adjusted by the plurality of light adjustment elements to the modulator, and the method includes determining light adjustment information in accordance with which the light adjustment elements are controlled and determining, based on the predetermined image data, light adjustment information on light adjustment element that adjust light incident on the second pixel.

According to the configuration of the aspect of the invention, light adjustment information on the light adjustment element that adjust light incident on the first pixel is determined on the basis of the inputted image data, and light adjustment information on the light adjustment element that adjust light incident on the second pixel is determined on the basis of the predetermined image data. The light incident on the first and second pixel can therefore be adjusted.

### BRIEF DESCRIPTION OF THE DRAWINGS

The invention will be described with reference to the accompanying drawings, wherein like numbers reference like elements.

FIG. 1 shows the configuration of a projector.

FIG. 2 is a front view showing pixel areas of a display liquid crystal panel.

FIG. 3 is a front view showing pixel areas of a light adjustment liquid crystal panel.

FIG. 4 is a front view showing the state in which a light adjustment pixel area of the light adjustment liquid crystal panel and a pixel area of the display liquid crystal panel are superimposed on each other.

FIG. 5 shows the configuration of a light adjustment information determination section.

FIG. 6 is a flowchart showing the action of the light adjustment information determination section.

FIG. 7 is another flowchart showing the action of the light adjustment information determination section.

### DESCRIPTION OF EXEMPLARY EMBODIMENTS

An embodiment of the invention will be described below with reference to the drawings.

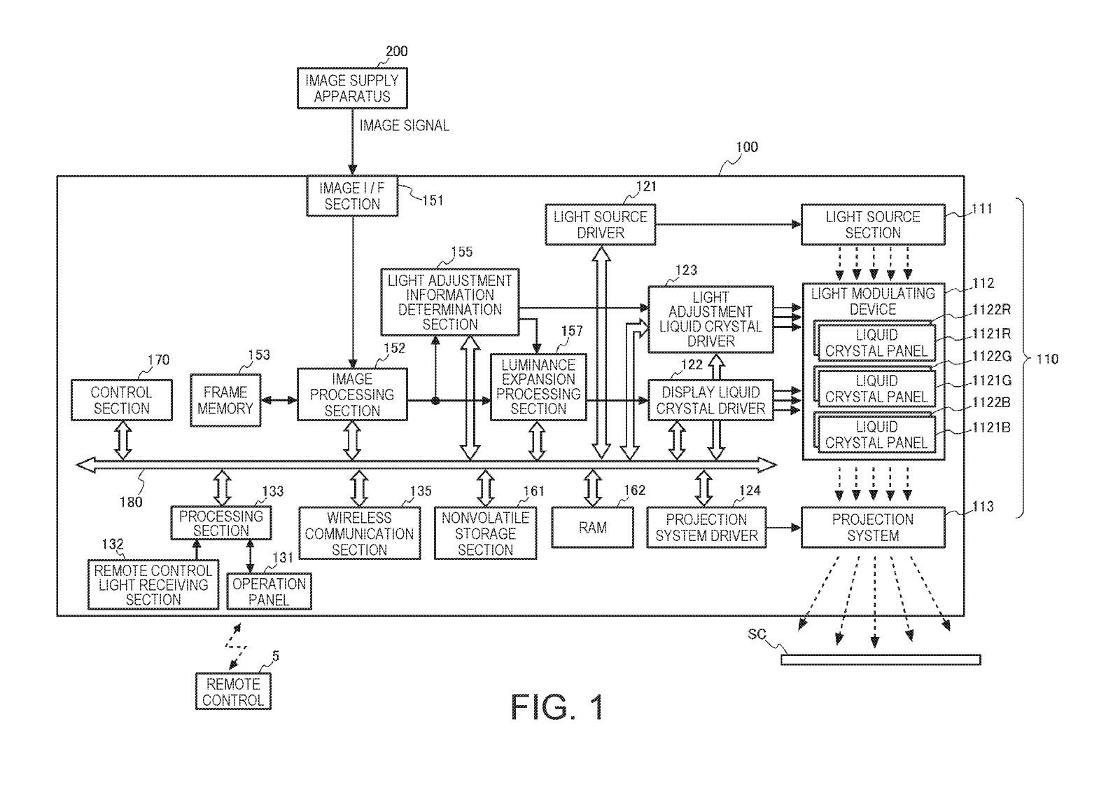

FIG. 1 is a block diagram showing the configuration of a projector (display apparatus) 100.

The projector 100 is an apparatus that is connected to an external image supply apparatus 200, such as a personal computer and a variety of video players, and projects an image based on an image signal supplied from the image supply apparatus 200 on a projection target. Examples of the image supply apparatus 200 may include a video reproduction apparatus, a DVD (digital versatile disk) reproduction apparatus, a television tuner, a CATV (cable television) set-top box, a video output apparatus, such as a video game console, and a personal computer. The projection target may be an object that is not uniformly flat, such as a building and an object, or may be an object having a flat projection surface, such as a screen SC and a wall surface of a building. In the present embodiment, a case where the projection target is the flat screen SC is presented by way of example.

The projector 100 includes an image interface section (interface is hereinafter abbreviated to I/F) 151 as an interface via which the projector 100 is connected to the image supply apparatus 200. The image I/F section 151 corresponds to the “image input section” in an aspect of the invention.

The image I/F section 151 includes a connector to which a cable is connected and an I/F circuit (neither of them is shown) and receives as an input an image signal supplied from the image supply apparatus 200, which is connected to the image I/F section 151 via the cable. The image I/F section 151 converts the inputted image signal into image data (hereinafter written as image data D1) and outputs the image data D1 to an image processing section 152.

The interface provided in the image I/F section 151 may, for example, be an interface for data communication, such as an interface that complies with Ethernet (registered trademark), IEEE1394, or USB. The interface of the image I/F section 151 may instead be an interface for image data, such as an interface that complies with MHL (registered trademark), HDMI (registered trademark), or DisplayPort.

Still instead, the image I/F section 151 may include, as the connector, a VGA terminal to which an analog video signal is inputted or a DVI (digital visual interface) terminal to which digital video data is inputted. The image I/F section 151 further includes an A/D conversion circuit, and when an analog video signal is inputted via the VGA terminal, the A/D conversion circuit converts the analog video signal into image data and outputs the image data to the image processing section 152.

The projector 100 includes the following broadly classified portions: a display section 110, which forms an optical image; and an image processing system that electrically processes an image to be displayed by the display section 110. The display section 110 will first be described.

The projection section 110 includes a light source section 111, a light modulating device 112, and a projection system 113.

The light modulating device 112 includes display liquid crystal panels 1121 and light adjustment liquid crystal panels 1122, which are provided on a color basis or for red (R), green (G), and blue (B).

In the display section 110, the light adjustment liquid crystal panels 1122 adjust the amount of light outputted from the light source section 111, and the display liquid crystal panels 1121 modulate the light to form image light. The modulated image light from the display liquid crystal panels 1121 is projected through the projection system 113 on the screen SC.

The light source section 111 includes a light source formed, for example, of a xenon lamp, an ultrahigh-pressure mercury lamp, or an LED (light emitting diode). The light source section 111 may include a reflector and an auxiliary reflector that guide light emitted from the light source to the light modulating device 112. The light source section 111 may further include a lens group (not shown) and a polarizer for enhancing the optical characteristics of projected light.

The light source section 111 is driven by a light source driver 121. The light source driver 121 is connected to an internal bus 180 and operates under the control of a control section 170, which is connected to the internal bus 180. The light source driver 121 turns on or off the light source in the light source section 111 under the control of the control section 170.

The light outputted from the light source section 111 is separated by a color separation system, such as dichroic mirrors, into R, G, and B color components, which are the three primary colors of light, and the color components are then incident on the display liquid crystal panels 1121 and the light adjustment liquid crystal panels 1122.

The light adjustment liquid crystal panels 1122 are formed of three light adjustment liquid crystal panels 1122R, 1122G, and 1122B. The light adjustment liquid crystal panel 1122R adjusts the amount of light (hereinafter referred to as light adjustment) incident on the display liquid crystal panel 1121R for R light. Similarly, the light adjustment liquid crystal panel 1122G adjusts the amount of light incident on the display liquid crystal panel 1121G for G light, and the light adjustment liquid crystal panel 1122B adjusts the amount of light incident on the display liquid crystal panel 1121B for B light. In the following sections, in a case where it is not necessary to distinguish the light adjustment liquid crystal panels 1122R, 1122G, and 1122B from one another when they are written, they are collectively written as the light adjustment liquid crystal panels 1122.

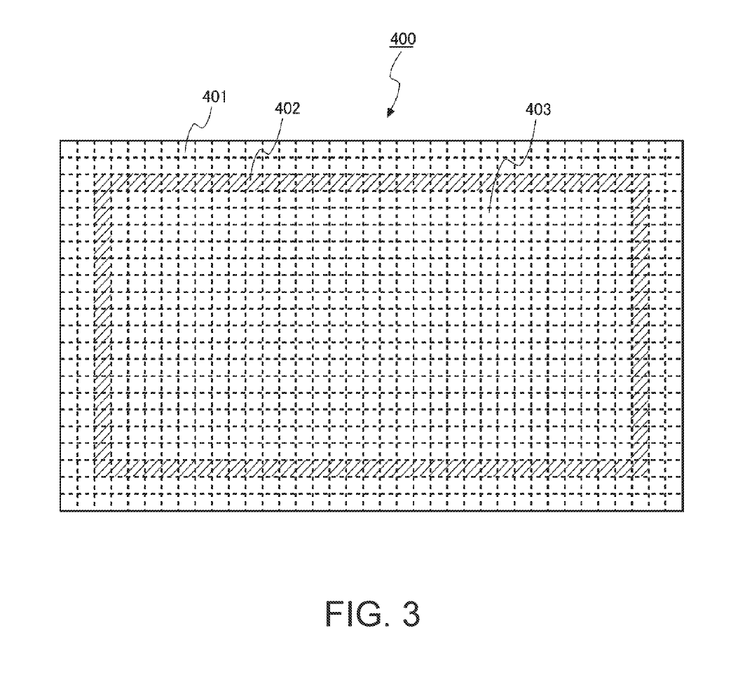

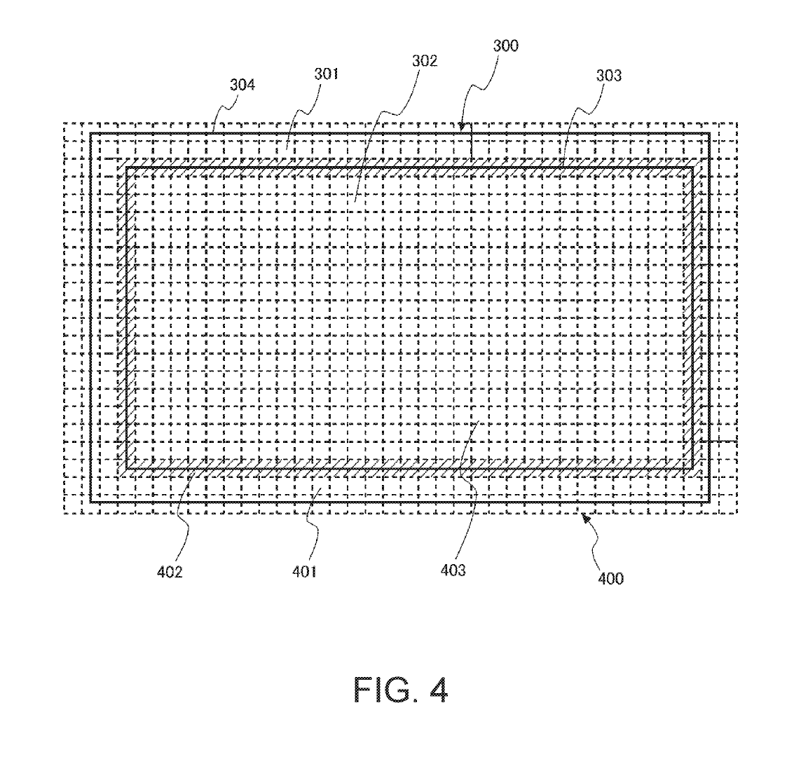

Each of the light adjustment liquid crystal panels 1122 is formed, for example, of a liquid crystal panel having a liquid crystal material encapsulated between a pair of transparent substrates. The liquid crystal panel has a rectangular light adjustment pixel area 400 (see FIGS. 3 and 4), in which a plurality of pixels are arranged in a matrix. A light adjustment liquid crystal driver 123 is connected to each of the light adjustment liquid crystal panels 1122. The light adjustment liquid crystal driver 123 is connected to the internal bus 180 and drives each of the light adjustment liquid crystal panels 1122 under the control of the control section 170.

The light adjustment liquid crystal driver 123 applies drive voltage to each of the light adjustment pixels of the light adjustment liquid crystal panels 1122 to control light transmittance of the light adjustment pixel. The light outputted from the light source section 111 passes through the light adjustment liquid crystal panels 1122, where the amount of the light is adjusted, and each of the display liquid crystal panels 1121 is illuminated with the light having undergone the light adjustment. The light adjustment liquid crystal panels 1122 and the light adjustment liquid crystal driver 123 correspond to the “illumination section” in an aspect of the invention.

The display liquid crystal panels 1121 are formed of three display liquid crystal panels 1121R, 1121G, and 1121B. In the following sections, in a case where it is not necessary to distinguish the display liquid crystal panels 1121R, 1121G, and 1121B from one another when they are written, they are collectively written as the display liquid crystal panels 1121.

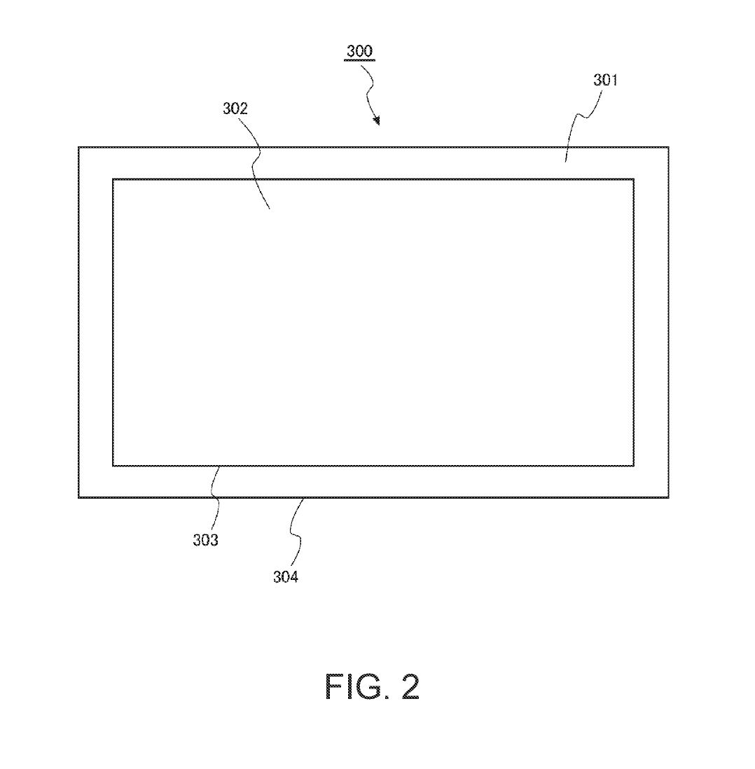

Each of the display liquid crystal panels 1121 is formed, for example, of a liquid crystal panel having a liquid crystal material sandwiched between a pair of transparent substrates. The liquid crystal panel has a rectangular pixel area 300 (see FIGS. 2 and 4) in which a plurality of pixels are arranged in a matrix. A display liquid crystal driver 122 is connected to each of the display liquid crystal panels 1121.

The display liquid crystal driver 122 is connected to a luminance expansion processing section 157, the display liquid crystal panels 1121 of the light modulating device 112, and the internal bus 180.

Display image data is inputted from the luminance expansion processing section 157 to the display liquid crystal driver 122.

The display liquid crystal driver 122 applies drive voltage to each of the pixels of the display liquid crystal panels 1121 in accordance with the inputted display image data to control the light transmittance of the pixel for generation of image light. The display liquid crystal panels 1121 and the display liquid crystal driver 122 correspond to the “modulation section” in an aspect of the invention.

The projection system 113 includes a zoom lens that enlarges and reduces a projected image, a focus adjustment mechanism that adjusts focusing, and other components. The projection system 113 projects the modulated image light from the light modulating device 112 on the screen SC.

A projection system driver 124 is connected to the projection system 113. The projection system driver 124 is connected to the internal bus 180.

The projection system driver 124 includes a stepper motor and a gear (neither of them is shown) and adjusts the position of a projection lens to perform zoom adjustment and focus adjustment under the control of the control section 170.

An operation panel 131 is mounted on a main body of the projector 100, and the operation panel 131 includes a variety of switches and indicator lamps that allow a user to operate the projector 100. The operation panel 131 is connected to a processing section 133. The processing section 133 turns on or off the indicator lamps on the operation panel 131 as appropriate in accordance with the operation state and setting state of the projector 100 under the control of the control section 170. When a switch on the operation panel 131 is operated, an operation signal corresponding to the operated switch is outputted from the processing section 133 to the control section 170.

The projector 100 includes a remote control 5 used by the user. The remote control 5 has a variety of buttons and transmits an infrared signal in response to operation performed on any of the buttons. A remote control light receiving section 132, which receives the infrared signal issued from the remote control 5, is mounted on the main body of the projector 100. The remote control light receiving section 132 decodes the infrared signal received from the remote control 5, generates an operation signal representing the content of the operation performed on the remote control 5, and outputs the operation signal to the control section 170.

The projector 100 includes a wireless communication section 135. The wireless communication section 135 is connected to the internal bus 180. The wireless communication section 135 includes an antenna, an RF (radio frequency) circuit, and other components that are not shown and performs wireless communication with an external apparatus under the control of the control section 170. The wireless communication scheme employed by the wireless communication section 135 can, for example, be a short-range wireless communication scheme, such as a wireless LAN (local area network), Bluetooth (registered trademark), UWB (ultra-wide band), and infrared communication, or a wireless communication scheme using a mobile phone line.

The image processing system of the projector 100 is primarily formed of the control section 170, which controls the projector 100, and further includes the image processing section 152, a frame memory 153, a light adjustment information determination section 155, the luminance expansion processing section 157, a nonvolatile storage section 161, and a RAM 162. The control section 170, the image processing section 152, the light adjustment information determination section 155, the luminance expansion processing section 157, the nonvolatile storage section 161, and the RAM 162 are connected to the internal bus 180. The light adjustment information determination section 155 corresponds to the “image processing apparatus” according to an aspect of the invention.

The image processing section 152 identifies the attribute of the image data D1 inputted from the image I/F section 151 under the control of the control section 170. For example, the image processing section 152 identifies the image size and resolution of the image data D1, determines whether the image data D1 contains a 2D (planar) image or a 3D (stereoscopic) image, determines whether the image data D1 contains still images or motion images, and identifies the frame rate of the image data D1. The image processing section 152 develops the image data D1 in the frame memory 153 on a frame basis and performs image processing on the image data D1 developed in the frame memory 153. Examples of the image processing performed by the image processing section 152 include a resolution conversion process, a digital zooming process, a color tone correction process, a luminance correction process, and a shape correction process. The image processing section 152 carries out a process specified by the control section 170 and carries out the process as required by using a parameter inputted from the control section 170. A plurality of the processes described above can be combined with one another and carried out. Image data having undergone the image processing performed by the image processing section 152 is written as image data D2.

Having completed the image processing, the image processing section 152 reads the processed image data D2 from the frame memory 153 and adds parting pixel data to the read image data D2. The pixel values of pixels that form the parting pixel data are stored in the nonvolatile storage section 161. The parting pixel data corresponds to the “predetermined image data” in an aspect of the invention. The image data D2 to which the parting pixel data is added is written as image data D3. The image processing section 152 outputs the image data D3 to the light adjustment information determination section 155 and the luminance expansion processing section 157. The parting pixel data will be described in detail with reference to FIGS. 2 to 4.

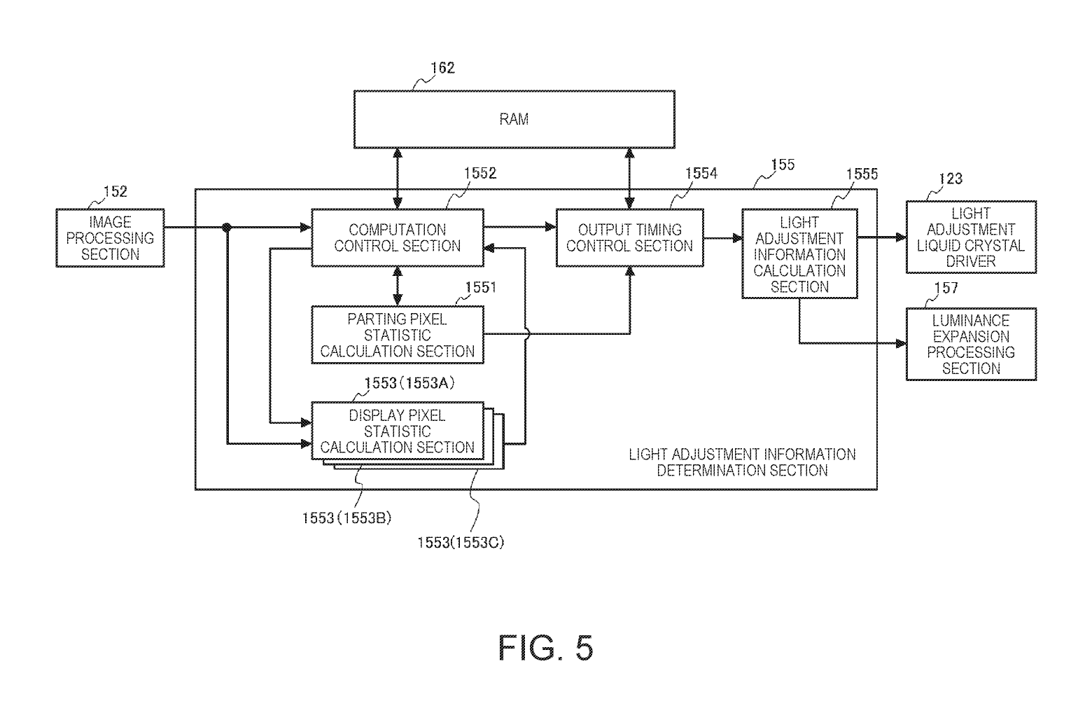

The light adjustment information determination section 155 determines light adjustment information. The light adjustment information is information used when the light adjustment liquid crystal driver 123 drives the light adjustment pixels of the light adjustment liquid crystal panels 1122. The light adjustment liquid crystal driver 123, which controls the light adjustment pixels of the light adjustment liquid crystal panels 1122 in accordance with the light adjustment information determined by the light adjustment information determination section 155, controls the amount of light that exits out of a light adjustment element and impinges on the pixel areas 300 of the display liquid crystal panels 1121 (hereinafter referred to as amount of incident light). The configuration of the light adjustment information determination section 155 will be described in detail with reference to FIG. 5.

The image data D3 is inputted from the image processing section 152 to the luminance expansion processing section 157, and the light adjustment information is inputted from the light adjustment information determination section 155 to the luminance expansion processing section 157.

The luminance expansion processing section 157 sets, on the basis of the light adjustment information inputted from the light adjustment information determination section 155, a luminance expansion ratio (gain) representing how much the luminance range of the image data D3 is expanded.

The luminance expansion processing section 157 further carries out the process of expanding the image data D3 inputted from the image processing section 152 by using the luminance expansion ratio set as described above to enlarge the luminance range of the image data D3 (hereinafter referred to as luminance expansion process). The luminance expansion processing section 157 outputs the image data having undergone the luminance expansion process as the display image data to the display liquid crystal driver 122.

The nonvolatile storage section 161 is formed of a flash memory, an EEPROM, or any other nonvolatile memory. The nonvolatile storage section 161 stores data to be processed by the control section 170 and a control program executed by the control section 170.

The RAM 162 includes a storage device, such as an SRAM (static random access memory). The RAM 162 stores data to be processed by the light adjustment information determination section 155 and data having been processed by the light adjustment information determination section 155.

The control section 170 includes a CPU (central processing unit), a ROM (read only memory), a RAM (random access memory), and other types of hardware that are not shown. The control section 170 causes the CPU to execute a basic control program stored in the ROM and an application program stored in the nonvolatile storage section 161 to control each portion of the projector 100. For example, the control section 170 controls the light source driver 121, the light adjustment liquid crystal driver 123, the display liquid crystal driver 122, the projection system driver 124, the image processing section 152, and the light adjustment information determination section 155 to cause them to project an image formed on the basis of image data on the screen SC.

FIG. 2 is a front view showing the pixel area 300 of each of the display liquid crystal panels 1121. FIG. 3 is a front view showing the adjustment light pixel area 400 of each of the light adjustment liquid crystal panels 1122. FIG. 4 is a front view showing the state in which the pixel area 300 of a display liquid crystal panel 1121 and the light adjustment pixel area 400 of the corresponding light adjustment liquid crystal panel 1122 are superimposed on each other.

The pixel area 300 of each of the display liquid crystal panels 1121 has an effective pixel area 302 and a parting pixel area 301, as shown in FIG. 2.

The light adjustment pixel area 400 of each of the light adjustment liquid crystal panels 1122 has a first light adjustment pixel area 401, a second light adjustment pixel area 402, and a third light adjustment pixel area 403, as shown in FIG. 3.

The effective pixel area 302 is disposed at the center of the pixel area 300, and the parting pixel area 301 is so disposed at the periphery of the pixel area 300 as to surround the effective pixel area 302.

The effective pixel area 302 has a plurality of first pixels as display pixels. In the effective pixel area 302 is displayed an image based on the image data D3 from which the parting pixel data is removed (that is, pixel data D2). That is, the first pixels in the effective pixel area 302 are so set as to have pixel values corresponding to the pixels that form the image data D2.

The parting pixel area 301 has a plurality of second pixels as display pixels. In the parting pixel area 301 is displayed an image based on the parting pixel data of the image data D3. That is, the second pixels in the parting pixel area 301 are so set to have the pixel values of the parting pixel data. The parting pixel data is, for example, data so set as to have a black pixel value, that is, a pixel value that minimizes light transmittance.

The second pixels in the parting pixel area 301 are used as reserve pixels used when pixel shift or any other undesirable phenomenon is corrected. The pixel shift is color shift that occurs among the R, G, and B three colors in an image projected on the screen SC. The pixel shift results from variation, for example, in precision of positional adjustment of the projection system 113 of the projector 100.

To correct the color shift that occurs among the R, G, and B three colors, the positions of the pixels used as the effective pixel area 302 of the pixel area 300 are changed for each of the R, G, and B display liquid crystal panels 1121. For example, even when a pixel is located in the same pixel position in the pixel areas 300, the pixel is used as a first pixel of the effective pixel area 302 in the R pixel area 300 but used as a second pixel of the parting pixel area 301 in the G pixel area 300 in some cases.

The same pixel position in the pixel areas 300 means, for example, that with respect to an origin that is the pixel located at the upper left corner of each of the pixel areas 300, pixels identified by the number of pixels from the pixel at the origin in the vertical direction and the number of pixels therefrom in the horizontal direction are located in the same position.

The third light adjustment pixel area 403 is disposed at the center of the light adjustment pixel area 400, and the second light adjustment pixel area 402 is disposed around the third light adjustment pixel area 403. The first light adjustment pixel area 401 is disposed around the second light adjustment pixel area 402.

The area hatched with oblique lines in FIG. 3 represents the second light adjustment pixel area 402. The area inside the second light adjustment pixel area 402 represents the third light adjustment pixel area 403, and the area outside the second light adjustment pixel area 402 represents the first light adjustment pixel area 401.

The light adjustment liquid crystal driver 123 drives each of the light adjustment pixel areas 401 to 403 on a light adjustment block basis. The light adjustment blocks in the present embodiment are each configured to be formed of 16 vertical light adjustment pixels by 16 horizontal light adjustment pixels. In the present embodiment, the description will be made assuming that the light adjustment blocks of the light adjustment pixel areas 401 to 403 have the same size, but the light adjustment blocks of the light adjustment pixel areas 401 to 430 may have different sizes. The blocks separated from one another with the broken lines shown in FIG. 3 represent the light adjustment blocks.

Further, in the present embodiment, the description will be made with reference to a case where the light adjustment element corresponds to the 16-pixel-by-16-pixel light adjustment block, but the number of light adjustment pixels that form the light adjustment block is not limited to 16 pixels by 16 pixels. For example, the light adjustment element may correspond to one light adjustment pixel, and the light adjustment liquid crystal driver 123 may drive each of the light adjustment pixels separately from one another.

The light adjustment blocks contained in each of the third light adjustment pixel areas 403 adjust light incident on the first pixels of the corresponding effective pixel area 302. In each of the pixel areas 300, consider the pixels corresponding to one light adjustment block contained in the third light adjustment pixel area 403 to be one group, and the group contains only first pixels but no second pixels.

The light adjustment blocks contained in the second light adjustment pixel area 402 adjust light incident on the first pixels in the effective pixel area 302 and second pixels in the parting pixel area 301. In the pixel area 300, consider the pixels corresponding to one light adjustment block contained in the second light adjustment pixel area 402 to be one group, and the group contains both first pixels and second pixels. The light adjustment blocks contained in the first light adjustment pixel area 401 adjust light incident on the second pixels in the parting pixel area 301. In the pixel area 300, consider the pixels corresponding to one light adjustment block contained in the first light adjustment pixel area 401 to be one group, and the group contains only second pixels but no first pixels.

FIG. 5 shows the configuration of the light adjustment information determination section 155.

The light adjustment information determination section 155 includes a parting pixel statistic calculation section 1551, a computation control section 1552, a display pixel statistic calculation section 1553, an output timing control section 1554, and a light adjustment information calculation section 1555.

The light adjustment information determination section 155 generates the light adjustment information. The light adjustment information determination section 155 generates the light adjustment information based on the configuration in which the light adjustment blocks of the third light adjustment pixel area 403, the second light adjustment pixel area 402, and the first light adjustment pixel area 401 operate differently.

The parting pixel statistic calculation section 1551 calculates statistics (amounts of characteristic) of the pixel values of pixel data displayed in the parting pixel area 301, where the light adjustment blocks of the first light adjustment pixel area 401 adjust light incident on the parting pixel area 301.

The second pixels in the parting pixel area 301 display the parting pixel data, which is the image data D3. The parting pixel statistic calculation section 1551 calculates the maximum, minimum, and average of the pixel values of the parting pixel data as the statistics. The parting pixel statistic calculation section 1551 calculates the statistics for each of the light adjustment blocks of the first light adjustment pixel area 401. The calculated statistics are called first statistics in the following sections. In a case where the entire parting pixel data has the same pixel value, the maximum, minimum, and average of the pixel values of the parting pixel data are equal to each other and are all equal to one pixel value of the parting pixel data.

The parting pixel statistic calculation section 1551 further calculates the statistics of the pixel values of pixel data displayed in the parting pixel area 301 out of the effective pixel area 302 and the parting pixel area 301, where the light adjustment blocks of the second light adjustment pixel area 402 adjust light incident on the effective pixel area 302 and the parting pixel area 301.

The light adjustment blocks of the second light adjustment pixel area 402 adjust the amount of light incident on first pixels in the effective pixel area 302 and second pixels in the parting pixel area 301, as described above. Out of the two areas, the parting pixel statistic calculation section 1551 calculates the statistics of the pixel values of the parting pixel data displayed by the second pixels in the parting pixel area 301. The parting pixel statistic calculation section 1551 calculates the maximum, minimum, and average of the pixel values of the parting pixel data as the statistics. The parting pixel statistic calculation section 1551 calculates the statistics for each of the light adjustment blocks of the second light adjustment pixel area 402. The calculated statistics are called second statistics below.

The parting pixel statistic calculation section 1551 calculates the maximum, minimum, and average of the pixel values of the parting pixel data as the statistics (first statistics and second statistics).

The pixel values of the parting pixel data are known values set in advance, and the parting pixel statistic calculation section 1551 calculates the first statistics and the second statistics in advance before an image signal is inputted to the projector 100. For example, the parting pixel statistic calculation section 1551 may calculate the first statistics and the second statistics immediately after the projector 100 is activated or may perform the calculation during a porch period. That is, the parting pixel statistic calculation section 1551 performs the calculation of the statistics in such a way that the calculation of the first statistics and the second statistics is completed before the timing at which the statistics are necessary. The porch period is a period starting from a point of time when the horizontal sync signal is inputted and ending at a point of time when the image data D3 is inputted. The parting pixel statistic calculation section 1551 outputs the calculated first statistics to the output timing control section 1554. The parting pixel statistic calculation section 1551 includes a memory (not shown) and stores the calculated second statistics in the memory.

The image data D3 and sync signals (horizontal sync signal and vertical sync signal) are inputted from the image processing section 152 to the computation control section 1552.

The computation control section 1552 identifies, on the basis of the inputted sync signals, pixels that form the display liquid crystal panels 1121 and display pixel data inputted next time from the image processing section 152 to the display pixel statistic calculation section 1553. The identified pixels are called target pixels below. The computation control section 1552 further identifies light adjustment blocks that adjust the amount of light incident on the target pixels (hereinafter referred to as target light adjustment blocks).

When the target light adjustment blocks are light adjustment blocks of the third light adjustment pixel area 403, the computation control section 1552 evaluates whether or not the RAM 162 has stored statistics related to the target light adjustment blocks. The statistics stored in the RAM 162 are called third statistics. In a case where the target light adjustment blocks have been selected as the light adjustment blocks that adjust the amount of light incident on the target pixels, the RAM 162 has stored the third statistics.

In the case where the RAM 162 has stored the third statistics related to the target light adjustment blocks, the computation control section 1552 reads the third statistics from the RAM 162 and outputs the third statistics to the display pixel statistic calculation section 1553. On the other hand, in a case where the RAM 162 has not stored the third statistics related to the target light adjustment block, the computation control section 1552 outputs no third statistics to the display pixel statistic calculation section 1553. The computation control section 1552 may further output data representing that no third statistics are present to the display pixel statistic calculation section 1553.

The third statistics calculated by the display pixel statistic calculation section 1553 are inputted to the computation control section 1552. The computation control section 1552, when the third statistics are inputted thereto, evaluates whether or not pixels which form the pixel area 300 and where the target light adjustment blocks adjust light incident on the pixel area 300 have all been selected as the target pixels. That is, the computation control section 1552 evaluates whether or not the calculation of the third statistics has been performed on all light adjustment pixels contained in the target light adjustment blocks. In a case where a result of the evaluation shows that the pixels which form the pixel area 300 and where the target light adjustment blocks adjust light incident on the pixel area 300 have not all been selected as the target pixels, the computation control section 1552 stores the third statistics inputted from the display pixel statistic calculation section 1553 in the RAM 162. In a case where a result of the evaluation shows that the pixels which form the pixel area 300 and where the target light adjustment blocks adjust light incident on the pixel area 300 have all been selected as the target pixels, the computation control section 1552 outputs the third statistics inputted from the display pixel statistic calculation section 1553 to the output timing control section 1554.

In the case where the target light adjustment blocks are light adjustment blocks of the second light adjustment pixel area 402 and the RAM 162 has stored the third statistics related to the target light adjustment blocks, the computation control section 1552 outputs the third statistics related to the corresponding target light adjustment blocks to the display pixel statistic calculation section 1553. In the case where the target light adjustment blocks are light adjustment blocks of the second light adjustment pixel area 402 and the RAM 162 has stored no third statistics related to the target light adjustment blocks, the computation control section 1552 acquires the second statistics from the parting pixel statistic calculation section 1551. The computation control section 1552 outputs the acquired second statistics to the display pixel statistic calculation section 1553.

The second statistics are statistics of the pixel values of the pixel data displayed in the parting pixel area 301 out of the effective pixel area 302 and the parting pixel area 301 where the light adjustment blocks of the second light adjustment pixel area 402 adjust light incident on the parting pixel area 301 out of the effective pixel area 302 and the parting pixel area 301. The computation control section 1552 outputs the second statistics to the display pixel statistic calculation section 1553 and causes the display pixel statistic calculation section 1553 to calculate the statistics including those related to the effective pixel area 302.

In the case where the target light adjustment blocks are light adjustment blocks of the first light adjustment pixel area 401, the computation control section 1552 causes the display pixel statistic calculation section 1553 to stop the statistic calculation or discards the third statistics calculated by the display pixel statistic calculation section 1553 and inputted from the display pixel statistic calculation section 1553.

Since the first statistics related to the light adjustment blocks of the first light adjustment pixel area 401 have already been calculated, the computation control section 1552 does not cause the display pixel statistic calculation section 1553 to perform the statistic calculation or does not use the statistics calculated by the display pixel statistic calculation section 1553 as the statistics related to the light adjustment blocks of the first light adjustment pixel area 401.

The pixel data on the pixels that form the image data D3 are sequentially inputted from the image processing section 152 to the display pixel statistic calculation section 1553. Further, the statistics (second or third statistics) are inputted from the computation control section 1552 to the display pixel statistic calculation section 1553.

The display pixel statistic calculation section 1553 includes three blocks, display pixel statistic calculation sections 1553A, 1553B, and 1533C. In the following description, in a case where it is not necessary to distinguish the display pixel statistic calculation sections 1553A, 1553B, and 1533C from one another when they are written, they are written as the display pixel statistic calculation sections 1553.

The display pixel statistic calculation section 1553A calculates the maximum of the pixel data as a statistic (amount of characteristic).

When the second or third statistics are inputted from the computation control section 1552, the display pixel statistic calculation section 1553A compares the maximum inputted as the second or third statistics with the pixel values of the pixel data inputted from the image processing section 152. When the pixel values of the inputted pixel data are greater than the second or third statistics, the display pixel statistic calculation section 1553A outputs the pixel values of the inputted pixel data as new third statistics to the computation control section 1552. When the pixel values of the inputted pixel data are smaller than or equal to the second or third statistics, the display pixel statistic calculation section 1553A directly outputs the second or third statistics to the computation control section 1552.

Further, when no second or third statistics are inputted from the computation control section 1552, the display pixel statistic calculation section 1553A directly outputs the pixel values of the pixel data inputted from the image processing section 152 as the third statistics.

The display pixel statistic calculation section 1553B calculates the minimum of the pixel data as a statistic (amount of characteristic).

When the second or third statistics are inputted from the computation control section 1552, the display pixel statistic calculation section 1553B compares the minimum inputted as the second or third statistics with the pixel values of the pixel data inputted from the image processing section 152. When the pixel values of the inputted pixel data are smaller than the second or third statistics, the display pixel statistic calculation section 1553B outputs the pixel values of the inputted pixel data as new third statistics to the computation control section 1552. When the pixel values of the inputted pixel data are greater than or equal to the second or third statistics, the display pixel statistic calculation section 1553B directly outputs the second or third statistics to the computation control section 1552.

Further, when no second or third statistics are inputted from the computation control section 1552, the display pixel statistic calculation section 1553B outputs the pixel values of the pixel data inputted from the image processing section 152 as the third statistics.

The display pixel statistic calculation section 1553C calculates the average of the pixel data as a statistic (amount of characteristic).

When the sum of the pixel values is inputted as the second or third statistic from the computation control section 1552 and a data number representing the number of sets of image data to be added to the sum is also inputted, the display pixel statistic calculation section 1553C adds the pixel values of the inputted pixel data sets to the sum of the pixel values. The display pixel statistic calculation section 1553C further adds 1 to the value indicated by the data number. The display pixel statistic calculation section 1553C outputs the calculated sum of the pixel values and the data number to the computation control section 1552.

When no second or third statistics are inputted from the computation control section 1552, the display pixel statistic calculation section 1553C uses the pixel values of the pixel data inputted from the image processing section 152 as the sum of the pixel values, sets the data number representing the number of summation at “1”, and outputs the thus sum and the data number to the computation control section 1552. The computation control section 1552 calculates the average on the basis of the sum of the pixel values and the data number inputted from the display pixel statistic calculation section 1553C.

In the present embodiment, the case where the maximum, minimum, and average of pixel values are calculated as the statistics calculated by the parting pixel statistic calculation section 1551 and the display pixel statistic calculation sections 1553 is presented. The statistics calculated by the parting pixel statistic calculation section 1551 and the display pixel statistic calculation sections 1553 are not limited to the values described above, and the median, mode, histogram, or any other representative value of pixel values may be calculated as the statistics.

The first statistics are inputted from the parting pixel statistic calculation section 1551 to the output timing control section 1554. The output timing control section 1554 relates the inputted first statistics to the light adjustment blocks of the first light adjustment pixel area 401 and stores them in the RAM 162. The first statistics are statistics in the parting pixel area 301, where the light adjustment blocks of the first light adjustment pixel area 401 adjust light incident on the parting pixel area 301.

Further, the third statistics are inputted from the computation control section 1552 to the output timing control section 1554. The output timing control section 1554 stores the inputted third statistics in the RAM 162.

The output timing control section 1554 reads the statistics (first and third statistics) related to the light adjustment blocks of the first to third light adjustment pixel area 401 to 403 from the RAM 162 after the statistics related to the light adjustment blocks of the first and second light adjustment pixel areas 401, 402 are provided. The output timing control section 1554 outputs the read statistics (first and third statistics) to the light adjustment information calculation section 1555.

The light adjustment information calculation section 1555 calculates, on the basis of the inputted third statistics, light adjustment information in accordance with which the light adjustment blocks of the first and second light adjustment pixel areas 401, 402 are controlled. The light adjustment information calculation section 1555 further calculates, on the basis of the inputted first statistics, light adjustment information in accordance with which the light adjustment blocks of the first light adjustment pixel area 401 are controlled.

The light adjustment information calculation section 1555 outputs the generated light adjustment information in accordance with which the light adjustment blocks of the first to third light adjustment pixel area 401 to 403 are controlled to the light adjustment liquid crystal driver 123.

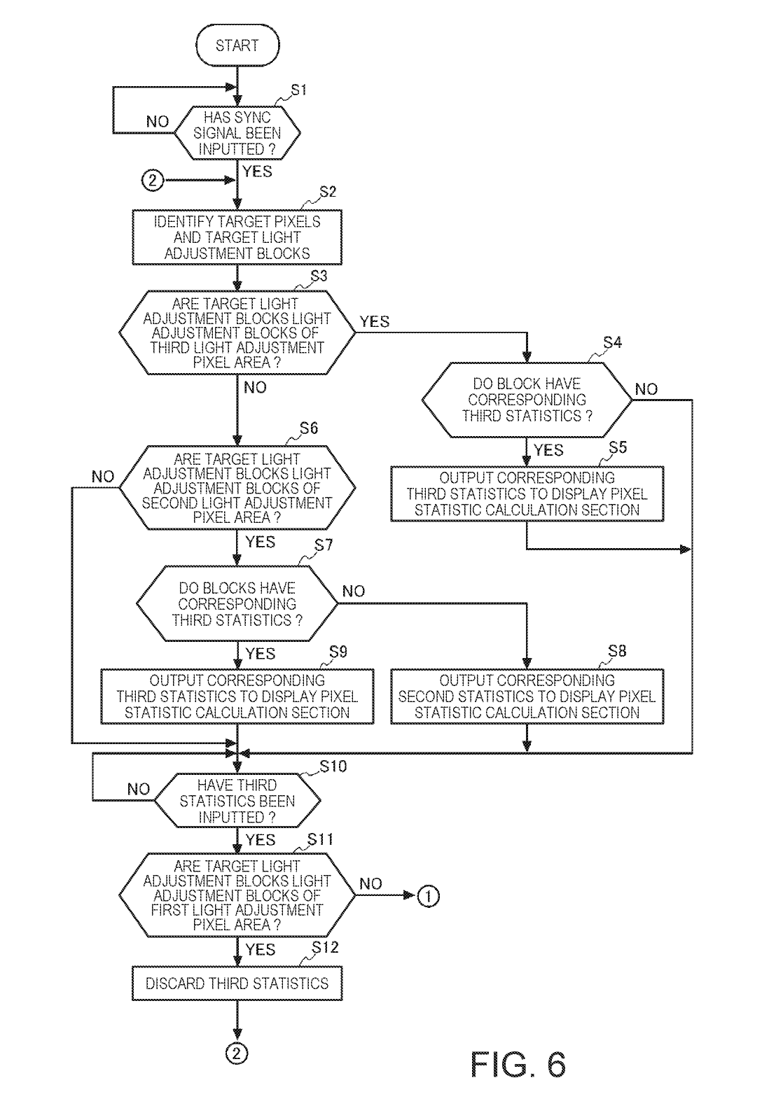

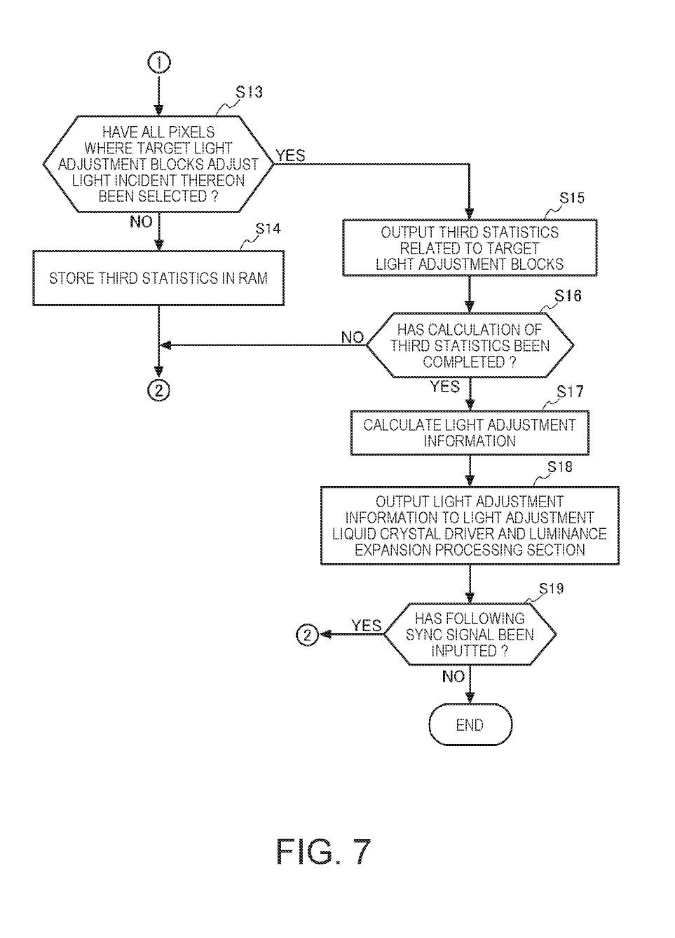

FIGS. 6 and 7 are flowcharts showing the action of the light adjustment information determination section 155.

The computation control section 1552 of the light adjustment information determination section 155 evaluates whether or not a sync signal (at least one of vertical sync signal and horizontal sync signal) has been inputted from the image processing section 152 (step S1). When the evaluation results in negation (step S1/NO), the computation control section 1552 waits until a sync signal is inputted. When the evaluation results in affirmation (step S1/YES), the computation control section 1552 identifies, on the basis of the inputted sync signal, pixels that form the display liquid crystal panels 1121 and display image data inputted to the display pixel statistic calculation sections 1553 (hereinafter target pixels) (step S2). The computation control section 1552 further identifies target light adjustment blocks that adjust the amount of light incident on the target pixels (step S2).

When the target light adjustment blocks are light adjustment blocks of the third light adjustment pixel area 403 (step S3/YES), the computation control section 1552 evaluates whether or not the third statistics related to the target light adjustment blocks have been stored in the RAM 162 (step S4). When the evaluation results in affirmation (step S4/YES), the computation control section 1552 reads the corresponding third statistics from the RAM 162 and outputs the read third statistics to the display pixel statistic calculation sections 1553 (step S5). The computation control section 1552 then waits until third statistics are inputted from the display pixel statistic calculation sections 1553 (step S10). When the evaluation results in negation (step S4/NO), the computation control section 1552 output no third statistics to the display pixel statistic calculation sections 1553 but waits until third statistics calculated by the display pixel statistic calculation sections 1553 are inputted from the display pixel statistic calculation sections 1553 (step S10). The computation control section 1552 may further output data representing no third statistics have been stored in the RAM 162 to the display pixel statistic calculation sections 1553.

When the target light adjustment blocks are light adjustment blocks of the second light adjustment pixel area 402 (step S3/NO and step S6/YES), the computation control section 1552 evaluates whether or not the RAM 162 has stored the third statistics related to the target light adjustment blocks (step S7).

When the evaluation results in negation (step S7/NO), the computation control section 1552 acquires the second statistics related to the target light adjustment block from the parting pixel statistic calculation section 1551 and outputs the second statistics to the display pixel statistic calculation sections 1553 (step S8). When the evaluation results in affirmation (step S7/YES), the computation control section 1552 reads the corresponding third statistics from the RAM 162 and outputs the read third statistics to the display pixel statistic calculation sections 1553 (step S9). The computation control section 1552 then wait until third statistics calculated by the display pixel statistic calculation sections 1553 are inputted from the display pixel statistic calculation sections 1553 (step S10).

When the target light adjustment blocks are not any of the light adjustment blocks of the second light adjustment pixel area 402 (step S3/NO and step S6/NO), the computation control section 1552 handles the target light adjustment blocks as light adjustment blocks of the first light adjustment pixel area 401. When the target light adjustment blocks are light adjustment blocks of the first light adjustment pixel area 401, the first statistics calculated in advance by the parting pixel statistic calculation section 1551 are used in place of the statistics calculated by the display pixel statistic calculation sections 1553. The computation control section 1552 therefore notifies the display pixel statistic calculation sections 1553 that no third statistics are outputted or the target light adjustment blocks are light adjustment blocks of the first light adjustment pixel area 401.

When no third statistics calculated by the display pixel statistic calculation sections 1553 are inputted (step S10/NO), the computation control section 1552 waits until the third statistics are inputted. When the third statistics are inputted (step S10/YES), and when the target light adjustment blocks are light adjustment blocks of the first light adjustment pixel area 401 (step S11/YES), the computation control section 1552 discards the inputted third statistics (step S12). The computation control section 1552 then returns to the identification in step S2 and proceeds to the process of identifying target pixels of image data inputted next to the display pixel statistic calculation sections 1553 and target light adjustment blocks.

When the target light adjustment blocks are light adjustment blocks of the first light adjustment pixel area 401, and when the computation control section 1552 controls the display pixel statistic calculation sections 1553 not to cause them to perform statistic calculation, the computation control section 1552 does not carry out the evaluation steps in steps S10 and S11 but proceeds to the evaluation step in S13 shown in FIG. 7.

When the target light adjustment blocks are light adjustment blocks of the first light adjustment pixel area 401 or the second light adjustment pixel area 402 (step S11/NO), the computation control section 1552 performs the evaluation in step S13.

In step S13, the computation control section 1552 evaluates whether or not the pixels in the pixel area 300 where the target light adjustment blocks adjust light incident on the pixel area 300 have all been selected as the target pixels (step S13). When the evaluation results in negation (step S13/NO), the computation control section 1552 stores the third statistics inputted from the display pixel statistic calculation sections 1553 in the RAM 162 (step S14).

When the evaluation results in affirmation (step S13/YES), the computation control section 1552 outputs the third statistics related to the target light adjustment blocks to the output timing control section 1554 (step S15). The output timing control section 1554 stores the inputted third statistics in the RAM 162.

The output timing control section 1554 evaluates whether or not the calculation of the third statistics have been completed for all light adjustment blocks of the first and second light adjustment pixel areas 401, 402 (step S16). When the evaluation results in negation (step S16/NO), the output timing control section 1554 waits until the third statistics are inputted from the computation control section 1552. Further, the computation control section 1552 returns to the identification in step S2 and proceeds to the process of identifying target pixels of image data inputted next to the display pixel statistic calculation sections 1553 and target light adjustment blocks.

When the evaluation in step S16 results in affirmation (step S16/YES), the output timing control section 1554 reads the third statistics related to the first and second light adjustment pixel areas 401, 402 and the first statistics related to the first light adjustment pixel area 401 from the RAM 162. The output timing control section 1554 outputs the read first and third statistics to the light adjustment information calculation section 1555.

The light adjustment information calculation section 1555 calculates light adjustment information on each of the light adjustment blocks of the first to third light adjustment pixel areas 401 to 403 on the basis of the first and third statistics inputted from the output timing control section 1554 (step S17). The light adjustment information calculation section 1555 outputs the calculated light adjustment information on each of the light adjustment blocks of the first to third light adjustment pixel areas 401 to 403 to the light adjustment liquid crystal driver 123 and the luminance expansion processing section 157 (step S18). The light adjustment liquid crystal driver 123 then controls each of the light adjustment blocks in accordance with the inputted light adjustment information to adjust the amount of light incident on the display liquid crystal panels 1121. The luminance expansion processing section 157 sets the luminance expansion ratio on the basis of the light adjustment information inputted from the light adjustment information determination section 155 and expands the image data D3 inputted from the image processing section 152 by using the set luminance expansion ratio to generate display image data.

The display liquid crystal driver 122 then controls the drive voltage applied to each of the pixels of the display liquid crystal panels 1121 in accordance with the display image data generated by the luminance expansion processing section 157 to control the light transmittance of the pixel to generate image light, and the generated image light is projected through the projection system 113 on the screen SC.

The computation control section 1552 then evaluates whether or not the following sync signal (at least one of vertical sync signal and horizontal sync signal) has been inputted from the image processing section 152 (step S19). When the evaluation results in affirmation (step S19/YES), the computation control section 1552 proceeds to the process in step S2. When the evaluation results in negation (step S19/NO), the computation control section 1552 terminates the entire processes.

As described above, the embodiment of the projector 100 and the display method involves the image I/F section 151, the display section 110, and the light adjustment information determination section 155. The display section 110 includes the display liquid crystal panels 1121 and the light adjustment liquid crystal panels 1122.

Image data is inputted via the image I/F section 151. Each of the display liquid crystal panels 1121 has a plurality of pixels. The plurality of pixels include the first pixels, which modulate light on the basis of the image data inputted to the image I/F section 151, and the second pixels, which modulate light on the basis of parting pixel data, which is predetermined image data. Each of the light adjustment liquid crystal panels 1122 includes a plurality of light adjustment blocks and outputs light adjusted by the plurality of light adjustment blocks to the corresponding display liquid crystal panel 1121.

The light adjustment information determination section 155 determines light adjustment information in accordance with which the light adjustment blocks of each of the light adjustment liquid crystal panels 1122 are controlled. The light adjustment information determination section 155 further determines, on the basis of the parting pixel data, light adjustment information on the light adjustment blocks that adjust light incident on the second pixels. Light adjustment corresponding to each of the pixels provided in the display liquid crystal panels 1121 can therefore be performed.

In particular, in a case where preset color image data is used as the parting pixel data, light adjustment information on the light adjustment blocks corresponding to the second pixels can be efficiently determined. The processing efficiency of the projector 100 including the light adjustment liquid crystal panels 1122, which adjust light, can therefore be improved.

The light adjustment information determination section 155 determines, on the basis of the image data inputted to the image I/F section 151 and the parting pixel data, light adjustment information on the light adjustment blocks that adjust light incident on the first and second pixels.

The values of the image data inputted to the image I/F section 151 and the values of the parting pixel data can therefore be reflected in the light adjustment information on the light adjustment blocks, whereby light adjustment information on the light adjustment blocks can be set to have optimum values.

The light adjustment information determination section 155 further determines, on the basis of the image data inputted to the image I/F section 151, light adjustment information on the light adjustment blocks that adjust light incident on the first pixels.

The values of the image data inputted to the image I/F section 151 can therefore be reflected in the light adjustment information on the light adjustment blocks, whereby light adjustment information on the light adjustment blocks can be set to have optimum values.

The light adjustment liquid crystal panels 1122 adjust light incident on a plurality of the pixels of the display liquid crystal panels 1121 on a light adjustment block basis.

In a case where the light adjustment blocks are blocks that adjust light incident on the first and second pixels, the light adjustment information determination section 155 determines the light adjustment information on the light adjustment blocks on the basis of the image data inputted to the image I/F section 151 and the parting pixel data.

The image data inputted to the image I/F section 151 and the parting pixel data can therefore be reflected in the light adjustment information on the light adjustment blocks, whereby the light adjustment information on the light adjustment blocks can be set to have optimum values.

In a case where the light adjustment blocks are light adjustment blocks that adjust light incident on the second pixels, the light adjustment information determination section 155 determines the light adjustment information on the light adjustment blocks on the basis of the parting pixel data.

The light adjustment information on the light adjustment blocks corresponding to the second pixels can therefore be efficiently determined, whereby the processing efficiency of the projector 100 including the light adjustment liquid crystal panels 1122, which adjust light, can be improved.

Further, the light adjustment information determination section 155 statistically processes the parting pixel data to calculate in advance the amounts of characteristic used to determine light adjustment information, and when image data is inputted to the image I/F section 151, the light adjustment information determination section 155 determines light adjustment information on the light adjustment blocks that adjust light incident on the second pixels on the basis of the amounts of characteristic calculated in advance.

The light adjustment information on the light adjustment blocks corresponding to the second pixels can therefore be efficiently determined, whereby the processing efficiency of the projector 100 including the light adjustment liquid crystal panels 1122, which adjust light, can be improved.

The light adjustment information determination section 155 statistically processes at least one of the image data inputted to the image I/F section 151 and the parting pixel data to calculate at least one of the maximum, minimum, and average of the pixel values of the image data as the amount of characteristic. The light adjustment information determination section 155 then determines light adjustment information on the basis of the calculated amount of characteristic.

The light adjustment information can therefore be determined on the basis of at least one of the maximum, minimum, and average of the pixel values of the image data.

The nonvolatile storage section 161 stores the pixel values of the parting pixel data. The light adjustment information determination section 155 uses the parting pixel data read from the nonvolatile storage section 161 to determine light adjustment information on the light adjustment blocks corresponding to the second pixels. The light adjustment information on the light adjustment blocks corresponding to the second pixels can therefore be readily determined.

The embodiment described above is a preferable embodiment of the invention. The invention is, however, not limited thereto, and a variety of variations can be implemented to the extent that they do not depart from the substance of the invention.

For example, in the embodiment described, the first statistic related to the first light adjustment pixel area 401 calculated by the parting pixel statistic calculation section 1551 may instead be inputted from an external apparatus.

For example, first statistics inputted from an external apparatus, such as a personal computer, are stored in the RAM 162. The computation control section 1552 reads the first statistics from the RAM 162 at timing when the first statistics are necessary and outputs the first statistics to the light adjustment information calculation section 1555. According to the configuration described above, the projector 100 needs to have no configuration that calculates the statistics, whereby the configuration of the projector 100 can be made compact.

In the embodiment described above, as for the light adjustment blocks of the first light adjustment pixel area 401, the parting pixel statistic calculation section 1551 calculates the first statistics on a light adjustment block basis, and the light adjustment information calculation section 1555 calculates light adjustment information on the basis of the first statistics. The reason for this is that the following two conditions are assumed as preconditions.

(1) The number of pixels in the parting pixel area 301 differs among the three colors R, G, and B.

(2) To calculate light adjustment information for a color, the statistics for the other colors are necessary. For example, to calculate light adjustment information for R, the statistics for G and B are necessary as well as the statistics for R.

In a case where the two conditions are not satisfied, for example, in a case where the number of pixels in the parting pixel area 301 is the same among the three colors, R, G, and B, the statistics may not be calculated for each of the light adjustment blocks of the first light adjustment pixel area 401, but light adjustment information may be directly calculated.

The image processing section 152 can be formed, for example, as an SoC-FPGA (System-on-a-Chip FPGA) (FPGA: field-programmable gate array) having an image processing function. The frame memory 153 is formed of a semiconductor memory device, such as a DRAM (dynamic random access memory). In FIG. 1, the frame memory 153 is externally connected to the image processing section 152 by way of example. The frame memory 153 may, of course, instead be mounted on the SoC that forms the image processing section 152.

Further, the light adjustment information determination section 155 can be formed of an SoC-FPGA (System-on-a-Chip FPGA) (FPGA: field-programmable gate array). The SoC that forms the light adjustment information determination section 155 may be an SoC different from the SoC that forms the image processing section 152 or may be the same SoC that forms the image processing section 152.

Further, the above embodiment has been described with reference to the configuration in which three transmissive or reflective liquid crystal panels corresponding to the RGB three colors are used as each of the sets of the display liquid crystal panels 1121 and the light adjustment liquid crystal panels 1122, but not necessarily in the invention. For example, a method using a combination of one liquid crystal panel and a color wheel may be employed. Further, a method using three digital mirror devices (DMDs), a DMD method using a combination of one digital mirror device and a color wheel, or other methods may be employed. When only one liquid crystal panel or DMD is used as the display liquid crystal panels 1121, no member corresponding to a light combining system, such as a cross dichroic prism, is necessary. Further, any light modulating device that can modulate light emitted from a light source can be employed with no problem instead of a liquid crystal panel or a DMD.

In the embodiment described above, the projector 100 presented as an example of the display apparatus is a front-projection projector, which performs projection from the side in front of the screen SC, but not necessarily in the invention. For example, a rear-projection projector, which performs projection from the side behind the screen SC, may instead be employed as the display apparatus. Still instead, a liquid crystal display, an organic EL (electro-luminescence) display, a plasma display, a CRT (cathode ray tube) display, an SED (surface-conduction electron-emitter display), and other display apparatus may be employed.

In the embodiment described above, the illuminator in the form of the light adjustment liquid crystal panels has been described. The illuminator may instead include an LED array, and light emitted from the LED array may be adjusted. In a case where the display apparatus is, for example, an FPD (flat panel display), the LED array described above may be disposed as the illuminator on the rear side of a liquid crystal panel or any other component of the FPD.

Each of the functional portions shown in FIGS. 1 and 5 represents a functional configuration and is not necessarily implemented in a specific form. That is, hardware corresponding to each of the functional portions is not necessarily implemented, and a single processor that executes a program can, of course, achieve the functions of the plurality of functional portions. Further, in the embodiment described above, part of the functions achieved by software in the embodiment described above may be achieved by hardware, or part of the functions achieved by hardware may be achieved by software. In addition, the specific detailed configuration of each of the other portions in the projector 100 can be arbitrarily changed to the extent that the change does not depart from the substance of the invention.

What is claimed is:

1. A display apparatus comprising:
an image input section that inputs image data;
a display section that includes a modulator having a plurality of pixels and an illuminator that includes a plurality of light adjustment elements and outputs light adjusted by the plurality of light adjustment elements to the modulator; and
a light adjustment information determination section that determines light adjustment information in accordance with which the light adjustment elements of the illuminator are controlled,
wherein the modulator has first pixel that modulate light based on the image data inputted to the image input section and second pixel that modulate light based on predetermined image data, and
the light adjustment information determination section determines, based on the predetermined image data, light adjustment information on the light adjustment element that adjust light incident on the second pixel.

2. The display apparatus according to claim 1, wherein the light adjustment information determination section determines, based on the image data inputted to the image input section and the predetermined image data, light adjustment information on the light adjustment element that adjust light incident on the first and second pixel.

3. The display apparatus according to claim 1, wherein the light adjustment information determination section determines, based on the image data inputted to the image input section, light adjustment information on the light adjustment element that adjust light incident on the first pixel.

4. The display apparatus according to claim 1,
wherein the illuminator adjusts light incident on a plurality of the pixels of the modulator on a light adjustment element basis, and
with regard to the light adjustment element that adjust light incident on the first and second pixel, the light adjustment information determination section determines light adjustment information on the light adjustment element based on the image data inputted to the image input section and the predetermined image data.

5. The display apparatus according to claim 4, wherein with regard to the light adjustment element that adjust light incident on the second pixel, the light adjustment information determination section determines light adjustment information on the light adjustment element based on the predetermined image data.

6. The display apparatus according to claim 1,
wherein the light adjustment information determination section statistically processes the predetermined image data to calculate an amount of characteristic used to determine light adjustment information, and
when image data is inputted to the image input section, the light adjustment information determination section determines, based on the amount of characteristic, light adjustment information on the light adjustment element that adjust light incident on the second pixel.

7. The display apparatus according to claim 1, wherein the light adjustment information determination section statistically processes at least one of the image data inputted to the image input section and the predetermined image data to calculate at least one of a maximum, a minimum, and an average of pixel values of the image data as an amount of characteristic and determines light adjustment information based on the calculated amount of characteristic.

8. The display apparatus according to claim 1, wherein the light adjustment information determination section determines, based on an amount of characteristic of the predetermined image data that is externally inputted, light adjustment information on the light adjustment element that adjust light incident on the second pixel.

9. The display apparatus according to claim 1, further comprising a storage section that stores pixel values of the predetermined image data.

10. The display apparatus according to claim 1,
wherein the modulator has a plurality of display pixels including the first pixel that display an image based on the image data inputted to the image input section and the second pixel that display an image based on the predetermined image data, and
the light adjustment information determination section determines, based on the predetermined image data, light adjustment information in accordance with which an amount of light of the image displayed by the second pixel is controlled.

11. The display apparatus according to claim 1, wherein the display apparatus is a projector including a light source and a projection system that projects an image displayed by the display section.

12. An image processing apparatus comprising:
a light adjustment information determination section provided in a display apparatus including a modulator having a plurality of pixels including first pixel that modulate light based on inputted image data and second pixel that modulate light based on predetermined image data and an illuminator that includes a plurality of light adjustment elements and outputs light adjusted by the plurality of light adjustment elements to the modulator, the light adjustment information determination section determining light adjustment information in accordance with which the light adjustment elements are controlled,
wherein the light adjustment information determination section determines, based on the predetermined image data, light adjustment information on light adjustment element that adjust light incident on the second pixel.

13. A display method used with a display apparatus including a modulator having a plurality of pixels including first pixel that modulate light based on inputted image data and second pixel that modulate light based on predetermined image data and an illuminator that includes a plurality of light adjustment elements and outputs light adjusted by the plurality of light adjustment elements to the modulator, the method comprising:
determining light adjustment information in accordance with which the light adjustment elements are controlled; and
determining, based on the predetermined image data, light adjustment information on light adjustment element that adjust light incident on the second pixel.
